(19) United States
(12) Patent Application Publication
(10) Pub. No.: US 2025/0044777 A1
(43) Pub. Date: Feb. 6, 2025

(54) FINDING POSSIBLE TECHNICAL CAUSES OF OR SOLUTIONS FOR MALFUNCTIONS OF A PRODUCTION CELL

(71) Applicant: ENGEL AUSTRIA GmbH, Schwertberg (AT)

(72) Inventors: Karlheinz MAYR, Schwertberg (AT); Thomas HUTTERER, Linz (AT); Herwig KOPPAUER, Linz (AT)

(21) Appl. No.: 18/920,059

(22) Filed: Oct. 18, 2024

Related U.S. Application Data
(63) Continuation of application No. PCT/EP2022/078620, filed on Oct. 14, 2022.

(30) Foreign Application Priority Data
Apr. 29, 2022 (EP) 22170796.1

(51) Int. Cl. G05B 19/418; G05B 13/04

(52) U.S. Cl. CPC G05B 19/41875; G05B 13/04; G05B 2219/32368

(57) ABSTRACT

A device and method are provided for finding possible technical causes of or solutions for malfunctions of a specific production cell which is one of a plurality of production cells. The specific production cell is built of a plurality of different objects and contains at least one cyclically operating shaping machine, and a computer program to configured to carry out such a method.

### BACKGROUND OF THE INVENTION

One aspect of the invention is in the field of finding possible technical causes of or solutions for malfunctions of a specific production cell which is one of a plurality of production cells. The specific production cell is built of a plurality of different objects and contains at least one cyclically operating shaping machine.

Another aspect of the invention refers to a device for finding possible technical causes of malfunctions of a specific production cell which is one of a plurality of production cells. The specific production cell is built of a plurality of different objects and contains at least one cyclically operating shaping machine.

Another aspect of the invention refers to a computer-implemented method for finding possible technical causes of or solutions for malfunctions of a specific production cell which is one of a plurality of production cells. The specific production cell is built of a plurality of different objects and contains at least one cyclically operating shaping machine.

Yet another aspect of the invention refers to a computer program which when the program is executed by a computer causes the computer to be configured as a device for finding possible technical causes of or solutions for malfunctions of a specific production cell or to carry out a method for finding possible technical causes of or solutions for malfunctions of a specific production cell.

Still another aspect of the invention refers to a data carrier signal carrying such a computer program.

U.S. Pat. No. 4,658,370 A teaches a device for building and interpreting a knowledge model having separate portions encoding control knowledge, factual knowledge, and judgmental rules in the automotive field. An operator can provide values regarding to specific questions to receive help for the retrieval of knowledge.

EP 3 551 420 B1 teaches a method for evaluating and/or visualizing a process state of a production system, which contains at least one cyclically operating shaping machine, including the steps of: continuously or at discrete times, determining the value of a plurality of selected process variables, and comparing the current value of each selected process variable and/or a variable derived therefrom with one or more reference values by means of a computing unit, and determining a deviation or a rate of change. Each selected process variable is assigned to at least one logical group by the computing unit; at least two different logical groups are provided; and for each logical group, a state of the logical group is evaluated by the computing unit based on the process variables assigned to the logical group and/or is visualized by a display device.

EP 3 754 447 A1 teaches a device for monitoring a production facility, wherein the device includes a computing unit, at least one sensor, a memory unit, and an output device. In the memory unit, in each of at least one process variable set, at least three possible process states are stored and at least one algorithm is stored by which the one of the different possible process states actually present can be calculated, the possible process states that differ in relation to the respective process variable set are classified according to whether measures are necessary or recommended, the commands by the computing unit prompt it to execute the associated algorithm and thus to calculate which of the different possible process states is actually present and to check whether the actually present process state is classified as such a process state, to generate and output an electronic message depending on the calculated process state.

EP 3 774 267 A1 teaches a method for the automatic process monitoring and/or process diagnosis of a piece-based process, in particular a production process, in particular an injection-molding process, including the steps:
a) performing an automated reference finding in order to obtain reference values from values of at least one process variable
b) performing an anomaly detection on the basis of the reference values found in step (a) c) performing an automated cause analysis and/or an automated fault diagnosis on the basis of a qualitative model of process relationships and/or on the basis of dependencies of various process variables on each other

Known techniques do not enable an operator of a production cell to find quickly and reliably, in a computer-assisted way, possible technical causes of or solutions for, in particular the most probable technical cause or solution, malfunctions of a specific production cell based on an observation made by the operator regarding the specific production cell because they have fixed schemes for possible technical causes or solutions which do not take into account the specific production cell.

### SUMMARY OF THE INVENTION

It is an object of the invention to provide a device and a computer-implemented method for finding quickly and reliably, in a computer-assisted way, possible technical causes of, in particular the most probable technical cause, or solutions for, in particular the best solution, malfunctions of a specific production cell based on an observation made by the operator regarding the specific production cell.

Still other objects and advantages of the invention will in part be obvious and will in part be apparent from the specification and drawings.

The term “electronic computing unit” as it is used in the context of this disclosure describes the smallest entity of a CPU that can independently read and execute program instructions. Each electronic computing unit appears to the operating system as an independent processor that can be addressed in a parallel manner. Each CPU known in the art provides at least one electronic computing unit, but in the context of high-performance computing modern computer systems usually have more than one electronic computing unit. For example, the CPU can be a multicore-processor having a plurality of cores. A core is an independent actual processing unit within the CPU that can read and execute program instructions independently from other cores of the CPU. Further each core can allow multi-threading, i.e., one physical core appears as multiple processing entities to the operating system, sometimes referred to as “hardware threads”. In other cases, each core of the CPU can be a single processing entity or the CPU itself can be a single processing entity. Furthermore, it is to be understood that the term CPU is supposed to encompass GPUs.

In the present disclosure the term “machine interface” denotes any thing that allows providing input to and/or getting output from the device. In particular, the machine interface can be a Human-Machine-Interface (in particular for human operators, in short “HMI”) or a data bus (in particular for non-human operators such as a software agent).

One object of the disclosure relates to a device for finding possible technical causes of or solutions for malfunctions of a specific production cell which is one of a plurality of production cells, wherein the specific production cell is built of a plurality of different objects and contains at least one cyclically operating shaping machine, comprising:
at least one electronic computing unit,
at least one machine interface operatively coupled to the at least one electronic computing unit, and
at least one knowledge model providing, for all production cells of the plurality of production cells, information that specifies for a plurality of possible malfunctions which objects that are present in one or more of the productions cells of the plurality of production cells can cause a given malfunction.

The at least one electronic computing unit is configured to:
accept input by an operator of the specific production cell specifying an observation observed by the operator regarding a malfunction of the specific production cell,
based on the input, access the at least one knowledge model and, for those objects which form part of the specific production cell, identify at least one object which can exhibit a malfunction which is consistent with the observation of the operator of the specific production cell,
calculate, using an algorithm, at least the most probable technical cause of or solution for the specific combination of the observation provided as input by the operator, and
provide the calculated at least one technical cause or solution to the operator via the at least one machine interface.

Another object of the invention relates to a computer-implemented method for finding possible technical causes of or solutions for malfunctions of a specific production cell which is one of a plurality of production cells, wherein the specific production cell comprises a plurality of different objects (i.e., is built of a plurality of different technical components and is configured to operate in different process steps) and contains at least one cyclically operating shaping machine, using:
at least one electronic computing unit,
at least one machine interface operatively coupled to the at least one electronic computing unit,
at least one knowledge model providing, for all production cells of the plurality of production cells, information that specifies for a plurality of possible malfunctions which objects that are present in one or more of the productions cells of the plurality of production cells can cause a given malfunction,
   and comprising at least the following steps:
accept input by an operator of the specific production cell specifying an observation observed by the operator regarding a malfunction of the specific production cell,
based on the input, access the at least one knowledge model and, for those objects which form part of the specific production cell, identify at least one object which can exhibit a malfunction which is consistent with the observation of the operator of the specific production cell,
calculate, using an algorithm, at least the most probable technical cause of or solution for the specific combination of the observation provided as user input by the operator, and
provide the calculated at least one technical cause or solution to the operator via the at least one machine interface.

Yet another object of the invention relates to a computer program which when the program is executed by a computer causes the computer to be configured as a device according to one of the embodiments described in this disclosure or to carry out a method according to one of the embodiments described in this disclosure.

Still another object of the invention refers to a data signal carrying such a computer program.

Preferred embodiments of the invention are described in dependent claims. In order not to duplicate text passages, whenever an embodiment of the inventive device is described, this is to be understood to refer to the inventive method and vice-versa. It is also to be understood that the phrase “technical cause or solution” is to be interpreted as meaning “to provide only a technical cause” or “to provide only a solution” or “to provide both, a technical cause and a solution”.

In some cases the “operator” addressed in the present disclosure is a human, e.g. an operator of one or more production cells or a service technician sent by a manufacturer of one or more of the objects of the production cell, in particular of the cyclically operating shaping machine.

In some cases the term “operator” does not refer to a human being but to non-human entities such as software agents or observation systems, e.g. such as described in EP 3 551 420 B1 or EP 3 754 447 A1.

The production cell can contain exactly one or more than one cyclically operating shaping machine.

In addition to the at least one cyclically operating shaping machine the production cell can contain peripheral devices such as a robot, a thermal control device for the at least one cyclically operating shaping machine, and so on.

There are different possibilities for the algorithm that is used to calculate the at least one technical cause or solution such as a shortest path algorithm or a maximum flow algorithm.

A preferred example of a cyclically operating shaping machine is an injection molding machine or an injection press, in particular for the manufacturing of plastic parts.

The observations observed by the operator regarding a malfunction of the specific production cell can refer to observations made by a human operator solely based on human senses without assistance by a device (e.g., such as an oily hose or noise of unknown origin) and/or it can refer to observations made by a human operator based on readings from at least one sensor or observation system or assistance system of the production cell (e.g., such as sensor values regarding temperature values, pressure values, error messages; warnings of a monitoring system, frequent requests for spare parts, and so on) and/or it can refer to observations made by non-human operators on the basis of signals from at least one sensor or from an observation system.

The observations observed by the operator regarding a malfunction of the specific production cell can refer to the physical condition of objects (e.g., an oily hose) or products produced by the cyclically operating shaping machine (e.g., malformed products) and/or it can refer to observations made by the operator with respect to the production process (e.g., cycle time too high) or other processes (e.g., time for heating up objects is too long).

The machine interface can comprise at least one display as an output device. The display can be in the form of a computer monitor, tablet, a cell phone, a device to be worn on the body of an operator, such as a smart watch or smart glasses, and so on.

The machine interface can comprise at least one keyboard as an input device. In addition, or alternatively, it can comprise a voice input device and/or a camera as an input device.

The knowledge model comprises:
different objects such as files, mechanical components, process steps, parameters, solutions, problems,
different types of relations and defined relations between the different objects, and
collection of structured (e.g., mechanical component, solution, . . . ) and/or unstructured data (e.g., file like PDF).

In particular, the knowledge model can be at least one database.

The knowledge model can contain the relations between the observations and different objects (e.g., different machine components) for the plurality of production cells, production processes, and/or cyclically operating shaping machines. It can also contain technical causes and/or solutions. It can be constructed based on the knowledge of human experts by the manufacturer and/or be built and/or be updated by an operator.

In some embodiments, in addition to the at least one knowledge model, a statistics database is used. It contains the frequencies of occurrence or probabilities for each observation (e.g., globally for the specific machine type of the injection molding machine, locally in the production area for the specific machine type, or for the specific injection molding machine) such that the probabilities of each possible observation can be calculated. The observations in the knowledge model may have further labels or tags, like the application type, and the machine operator can restrict the observations provided by the device by inserting additional labels or tags. The statistics database can be constructed based on the knowledge of human experts by the manufacturer and/or be built and/or be updated by an operator.

The device can be configured as one physical component comprising the at least one electronic computing unit, the at least one machine interface, and the at least one database.

Alternatively, all, or at least some of the aforementioned components can be situated in different physical devices and can communicate with each other via at least one data channel and/or the cloud.

In some embodiments, the at least one electronic computing unit is configured to accept user input to identify the specific production cell and/or a specific cyclically operating shaping machine. Alternatively, the at least one electronic computing unit could be configured to retrieve this information automatically, e.g., if the machine interface is mounted to an object of a specific production cell the at least one electronic computing unit could infer the identity of the specific production cell via the identity of the machine interface that is used by an operator to contact the device.

In some embodiments, the at least one electronic computing unit is configured to provide a list of possible observations to the operator via the at least one machine interface and to accept user input selecting that observation of the list of possible observations which is a best match to the observation observed by the operator regarding a malfunction of the specific production cell. In this way, the operator can find the relevant observation in an assisted way. Alternatively, the operator could input the observation in free-text-form or verbally and the at least one electronic computing unit can use text or speech recognition to match the inputted observation to a list of stored observations.

In some embodiments, the at least one electronic computing unit can be configured to provide a list of objects present in the specific production cell (in this way the operator can find the relevant objects in an assisted way) and to provide the list of possible observations based on a selection of a specific object made by the operator. It is preferred that the list of possible observations is ordered according to the frequency of occurrence.

In some embodiments, the at least one electronic computing unit is configured to operatively connect to at least one statistics database which contains the frequencies of occurrence or probabilities for each observation in order to calculate at least the most probable technical cause or solution for the observation provided as input by the operator and to provide the calculated at least one technical cause or solution to the operator via the at least one machine interface. In some embodiments, only the most probable technical cause or solution might be provided to the operator. However, it is preferred that the at least one electronic computing unit is further configured to calculate a defined number of probable technical causes or solutions (e.g., two, three, or more technical causes or solutions) and to provide the calculated probable technical causes or solutions to the operator via the at least one machine interface.

The at least one statistics database can be generated, e.g., in different ways:
Every time an operator identified a solution or technical cause for a problem which occurred during operation of a machine this information is entered into a database. Also, in case a possible solution or technical cause turned out not to be a valid solution or technical cause at all, this information is also entered into the database. After enough information has been accumulated a statistical analysis is done and correlations between problems and solutions or technical causes are being determined and probabilities are calculated. Of course, this process has to be done for all of the different objects and their relations.
The probabilities between problems or technical causes and solutions are defined by an expert.
Ad hoc probabilities (e.g., according to an equal distribution) are given and modified by machine learning.
A mixture of the three aforementioned ways, in equal terms or weighted.

In some embodiments, the at least one electronic computing unit is configured to calculate the probabilities of the probable technical causes or solutions, by using the probabilities of each technical cause or solution from the statistics database and calculating the overall probability for the combination of the selected observation and object, preferably by using a shortest path algorithm or a maximum flow algorithm.

In some embodiments, the at least one electronic computing unit is configured to provide at least one proposal for a solution based on the calculated at least one technical cause to the operator via the at least one machine interface.

In these embodiments, the at least one electronic computing unit can be configured to calculate the combined probabilities for different solutions based on the calculated technical causes. For the calculation, the statistics data from the statistics database can be combined with a possible up ranking of selected technical causes by the operator.

In some embodiments, the at least one electronic computing unit is configured to operatively connect to a knowledge model providing, for different observations and/or malfunctions, possible solutions or technical causes responsible for the observations and/or malfunctions and the at least one electronic computing unit is further configured to provide to the operator via the at least one machine interface at least one possible cause or solution for the observation provided as user input by the operator and the object selected by the operator.

In some embodiments, the at least one electronic computing unit is configured to accept input by the operator specifying whether a proposed solution has worked and to use this input to update the statistics database.

In some embodiments, the at least one electronic computing unit is configured to accept input by the operator:
to build and/or update a user-specific knowledge model, and/or
to build and/or update a user-specific statistics database.

In some embodiments, the at least one electronic computing unit is configured to:
identify at least two different objects which can exhibit a malfunction which is consistent with the observation of the operator of the specific production cell,
provide the at least two identified objects to the operator via the at least one machine interface,
accept input by the operator selecting one of the at least two provided identified objects, and
calculate at least one technical cause or solution for the specific combination of:
   the observation provided as input by the operator, and
   the object selected by the operator.

Although in the following preferred embodiments of the invention, the cyclically operating shaping machine is assumed to be an injection molding machine it is to be understood that the following description also relates to cyclically operating shaping machines in general.
A first example of the invention:

A machine operator of a production cell comprising an injection molding machine detects oil loss of the injection molding machine. The machine operator inspects the injection molding machine and detects an oily hose. The machine operator has no idea, why the injection molding machine loses oil and starts the inventive device to investigate the problem in detail. At first, using the machine interface of the device, the operator selects the specific production cell and the specific injection molding machine, e.g., by inserting the product ID of the production cell or by selecting the injection molding machine in a representation of the local machine park at the production site. In a first response, the device can give, via the machine interface, an overview of the currently most probable possible observations of the selected type of injection molding machine, e.g., globally over all machines of this type, or locally over the machines of this type on the production site.

The machine operator selects that observation of the list of possible observations which is a best match to the observation observed by the machine operator regarding a malfunction of the specific production cell. In this specific example the observation is “oily” with respect to the component “hose”. The machine operator might insert the observation using a textual input device such as a keyboard of the machine interface. The device identifies all objects of the specified production cell that could be the cause for the observation “oily hose” (e.g., hose, hydraulic block, and oil pump) based on information about the specific production cell and/or the specific injection molding machine, like the machine type, and provides them to the machine operator via the machine interface, e.g., as a list. In a specific embodiment of the invention, the device sorts the provided objects according to the frequency (probability) each object usually causes the selected observation (e.g., 1. hose, 2. oil pump, 3. hydraulic block). In the next step the machine operator selects a specific object—e.g., the hose—, which can cause the observation “oily hose”.

Alternatively, the device provides a list of all objects of the production cell, or the injection molding machine, and the machine operator selects an object of the production cell and gets all possible observations that can be caused by the selected object, preferably sorted by the frequency (probability) of occurrence. In this specific example, the machine operator then selects the observation “oily hose”.

The ECU of the device calculates, for the specific combination of selected observation and object (in this example the combination “oily” and “hose”) a possibly pre-defined number of most probable technical causes that can lead to the observation for the selected object and provides them to the machine operator via the machine interface, e.g., as a sorted list according to the probability of each technical cause. In this specific example, the two most probable technical causes are “hose is torn” and “pump has leakage”. Based on this information, the machine operator can inspect the problem at the injection molding machine. The machine operator inspects the hose and concludes that the hose is OK. Thus, the machine operator selects the second most probable cause “pump has leakage”.

In the next interaction step, the device outputs the most probable possible solutions via the machine interface and technical causes that may lead to the pump leakage. As it is in the interest of the machine operator to start production as fast as possible, the machine operator selects the provided solution “install new pump”. To prevent future problems with the pump, the machine operator also wants to analyze, why the pump may have failed. The machine operator can perform this investigation independently or can request support by the machine manufacturer. Therefore, the device provides further input possibilities via the machine interface: “find root causes” or “hand over root cause analysis to service personnel”. In this specific example, the machine operator selects “hand over root cause analysis to service personnel”.

The service employee can enter the system at the current point of input and continue with the root cause analysis. In the specific example, the device outputs the following root causes via the machine interface: “system pressure limit exceeded” and “pump sealing incorrectly assembled”. In the next step, the service employee selects one possible root cause and gets further information, regarding which system parameters to analyze to confirm or exclude the root cause. Based on this information, the service employee analyzes the parameters of the hydraulic system and detects a defective pressure relief valve that may have caused a too high system pressure that has caused the pump failure (leakage). In the final step, the service operator changes the defective valve.
A second example of the invention:

The object of following embodiment is to propose the most probable underlying technical problem and the solution for an observation made by a machine operator at a production cell.

The probabilities can be calculated based on the configuration and type of the production cell, and/or in particular of the injection molding machine, and the specific history of the production cell, and/or in particular of the injection molding machine.

Based on the input of the serial number of the production cell via the machine interface by the machine operator, the device requests all relevant possible observations of the production cell from a database (the knowledge model). These are all possible observations that are labeled or tagged with the specific type of the production cell in the database.

From the set of possible observations, the device requests the probabilities of each possible observation from a second database (the statistics database) that contains the frequencies of occurrence for each observation, globally for the specific machine type of the injection molding machine, locally in the production area for the specific machine type, or for the specific injection molding machine. The observations in the knowledge model may have further labels or tags, like the application type, and the machine operator can restrict the observations provided by the device by inserting additional labels or tags.

The knowledge model furthermore contains the relations between the observations and different objects from the production cell or production process, e.g., different machine components.

Based on the selected observations, the device requests all objects from the production cell that are related to the observation from the knowledge model. The device requests the probabilities that the related objects cause the specific observation from the statistics database and outputs the information to the machine operator via the machine interface (preferably sorted according to their probabilities).

The machine operator selects one object, e.g., a specific object of the injection molding machine. For the selected observation and selected object, the device calculates the most probable technical causes that can lead to the observation at the selected object.

To calculate the probabilities of the probable technical causes, the device can use the probabilities of each technical cause from the statistics database and calculate the overall probability for the combination of the selected observation and selected object. Possible methods to calculate overall probabilities are the shortest path algorithm or the maximum flow algorithm. The proposed technical causes can be further reduced by the device, e.g., by checking if some exclusion criteria related to the technical causes (in the knowledge model) are met by comparing the criteria with data from the production process. Furthermore, the machine operator can impose one or more shown causes.

In the next step, the device requests possible solutions for the proposed technical causes from the knowledge model and calculates the probability for each solution. To do so, the device uses an algorithm and calculates the combined probabilities for the solutions based on the technical causes (without the imposed causes and their specific solutions). For the calculation, the statistics data from the statistics database is combined with a possible up ranking of selected technical causes by the machine operator. After the calculation, the device outputs the solutions according to their probability to the machine operator. It may also be favorable to rank the solutions according to other criteria, like the time or effort to implement the solution.

The machine operator can select a solution from the list, get detailed information concerning the solution and then confirm if a solution has solved the problem underlying the observation or not. This information can then be used by the device to update the statistics database, which is used for future solution findings. To do so, the device can up rank the confirmed paths (e.g., observation→cause→solution) through the knowledge model and down rank imposed paths. In the next step, the device can scale the probabilities of each path (observation→cause→solution) in the statistics database, so that the sum of a specific type (e.g., has cause) of outgoing relations from the node is equal to 1.

By confirming the solution, the device confirms the related cause and gives the machine operator the possibility to start a root cause analysis for the specific cause. In this case, the device again requests possible causes for the cause (the root causes) from the knowledge model and the related probabilities from the statistics database. In a specific case, the root cause may only be found by a multiple (sequential) search for causes (cause of the cause) of the specific confirmed problem (cause of the observation).

In a further embodiment, the operator can build up a user-defined knowledge model using the predefined relations between the different objects from the production cell or production process.

In a simple implementation, the operator can copy the predefined relations into a user-defined knowledge model. In this case, a further user-defined statistics database is initially empty. The operator can then insert further objects of the production cell or production process into the user-defined knowledge model and assign them to further objects available in the database. Additionally, the operator can insert observations, problems, and solutions into the user-defined knowledge model and relate them to each other and the objects from the production cell or production process. After the user-defined database has been built up, the operator can set it productive.

Each search, e.g., for observations or objects, then requests results from the knowledge model provided by the manufacturer and from the new user-defined knowledge model. For each path in the user-defined knowledge model, the device can up rank the confirmed paths (e.g., observation→cause→solution) through the knowledge model and can down rank imposed paths in the local statics database.

### BRIEF DESCRIPTION OF THE DRAWINGS

Embodiments of the invention are discussed making use of the enclosed figures wherein:

FIG. 1 shows an embodiment of the inventive device;

FIGS. 2A to 2E show an example for the inventive method based on the observation (“oily hose”);

FIG. 3 is a flow diagram for the example of FIG. 2;

FIG. 4A shows a possible logical structure of a part of the knowledge model;

FIG. 4B shows the knowledge model of FIG. 4A with added probabilities;

FIG. 5 shows another example for the inventive method;

FIG. 6 shows yet another example for the inventive method; and

FIG. 7 shows yet another example for the inventive method.

### DETAILED DESCRIPTION OF THE INVENTION

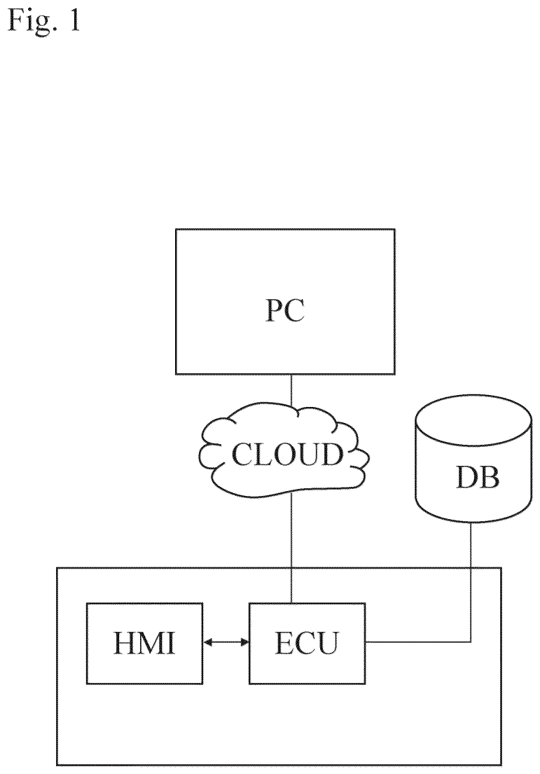

FIG. 1 shows a device comprising a machine interface and an electronic computing unit ECU (arranged in a single physical part) and a database DB which, in this example, comprises the knowledge model and the statistics database and is connected to the electronic computing unit ECU via a data network. The device is connected to a specific production cell PC via the cloud.

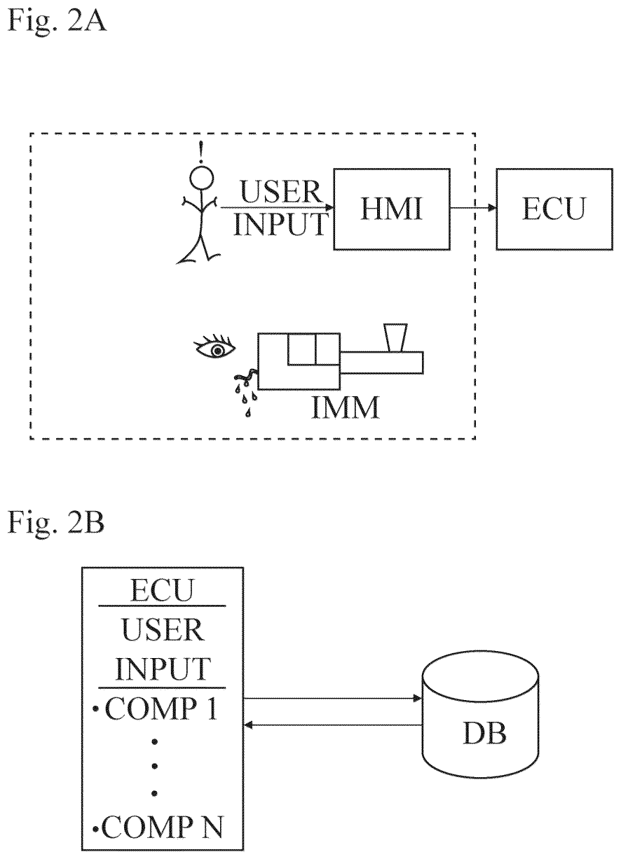

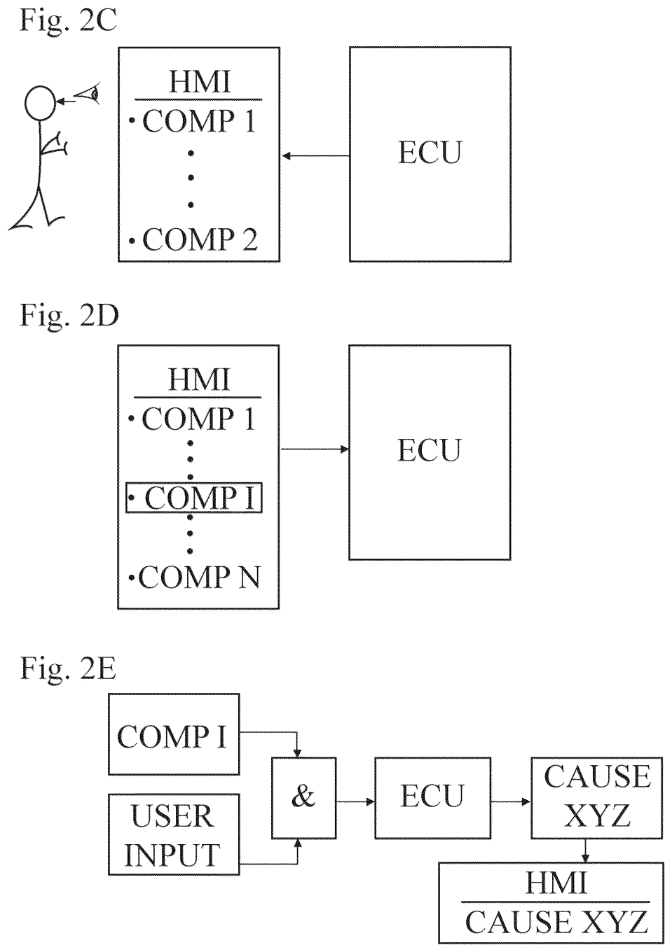

In the sequence of FIGS. 2A to 2E the inventive method is shown based on the observation “oily hose”:

FIG. 2A: A machine operator of a production cell comprising an injection molding machine detects oil loss of the injection molding machine IMM. Using the machine interface of the device, the operator selects the specific production cell and the specific injection molding machine IMM. The machine operator selects that observation out of the list of possible observations as INPUT which is a best match to the observation observed by the machine operator regarding a malfunction of the specific production cell. In this specific case the observation is “oily hose”.

FIG. 2B: Using the database DB the device identifies all objects COMP 1, . . . , COMP N of the specified production cell PC that could be the cause for the observation “oily hose” (e.g., hose, hydraulic block, and oil pump) based on information about the specific production cell PC and/or the specific injection molding machine IM as a list.

FIG. 2C: The device sorts the provided objects according to the frequency (probability) each object COMP 1 . . . COMP I . . . COMP N usually causes the selected observation (e.g., 1. hose, 2. oil pump, 3. hydraulic block).

FIG. 2D: The machine operator selects a specific object COMP I—e.g., the hose—, which can cause the observation “oily hose”.

FIG. 2E: The ECU of the device calculates, for the specific combination of selected observation and object COMP I the most probable technical causes CAUSE XYZ that can lead to the observation INPUT for the selected object COMP I and provides them to the machine operator via the machine interface.

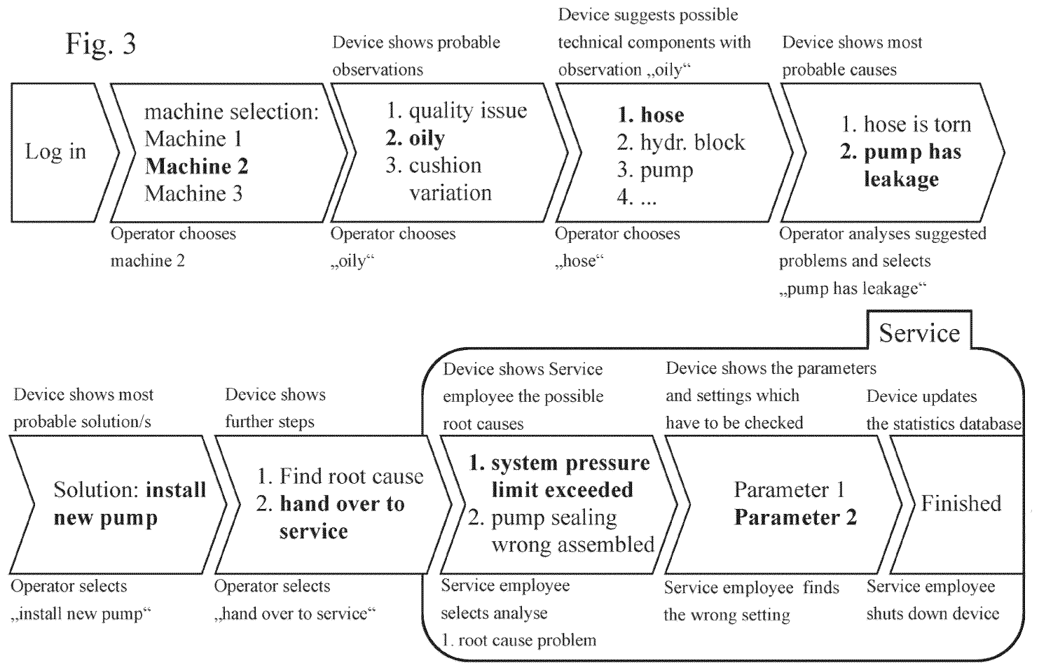

FIG. 3 shows a flow diagram for the example of FIG. 2. After the “Log in” step the operator selects “Machine 2” as the specific production cell out of three possible production cells. In this example, the production cells consist only of single machines.

Based on the observation of an oily hose, the operator selects the observation “oily” out of several possible observations and the object “hose” out of several objects for which the observation “oily” is an option.

The device calculates the most probable technical causes and offers the two possible technical causes “hose is torn” (most probable) and “pump leakage” (second most probable).

The operator selects “pump has leaking” and the device shows the most probable solution “install new pump”.

The device then offers a selection between “Find root cause” and “hand over to service”. The operator selects “hand over to service” and the device calculates the possible root causes and provides a service employee with two possible root causes. After the service employee has selected “system pressure limit exceeded” the device shows the parameters and settings to be checked, allowing the service employee to identify the wrong setting.

In a last step the device updates the statistics database.

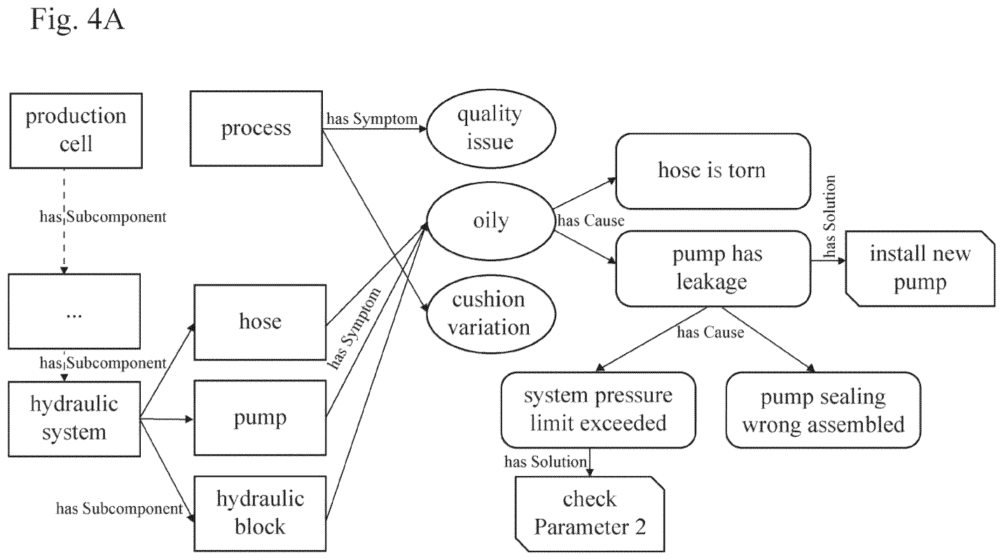

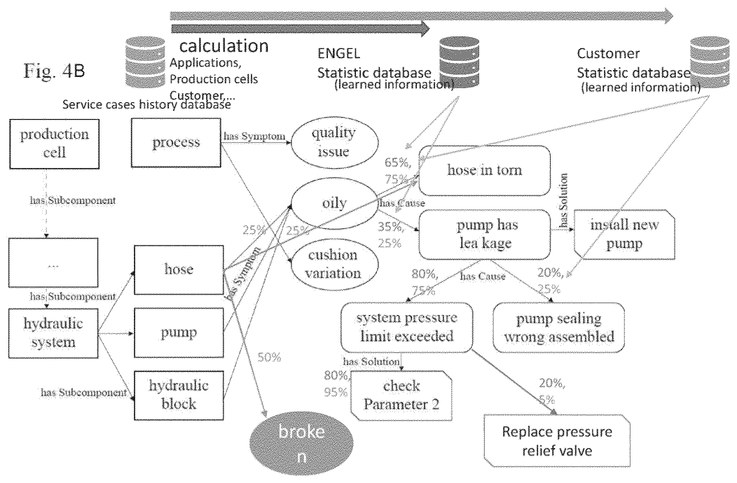

FIG. 4A shows a possible logical structure of the knowledge model which provides, for all production cells of a plurality of possible production cells (in FIG. 4A a single production cell is shown), information that specifies for a plurality of possible malfunctions which objects that are present in one or more of the productions cells of the plurality of production cells can cause a given malfunction.

In FIG. 4B probabilities have been added to the structure of FIG. 4A and the algorithm follows the path of the highest probability.

In another example of the invention the probabilities are calculated as a combination of initially provided expert knowledge and the history of confirmed paths through the knowledge database. The knowledge database can be represented by the graph shown in FIG. 4A.

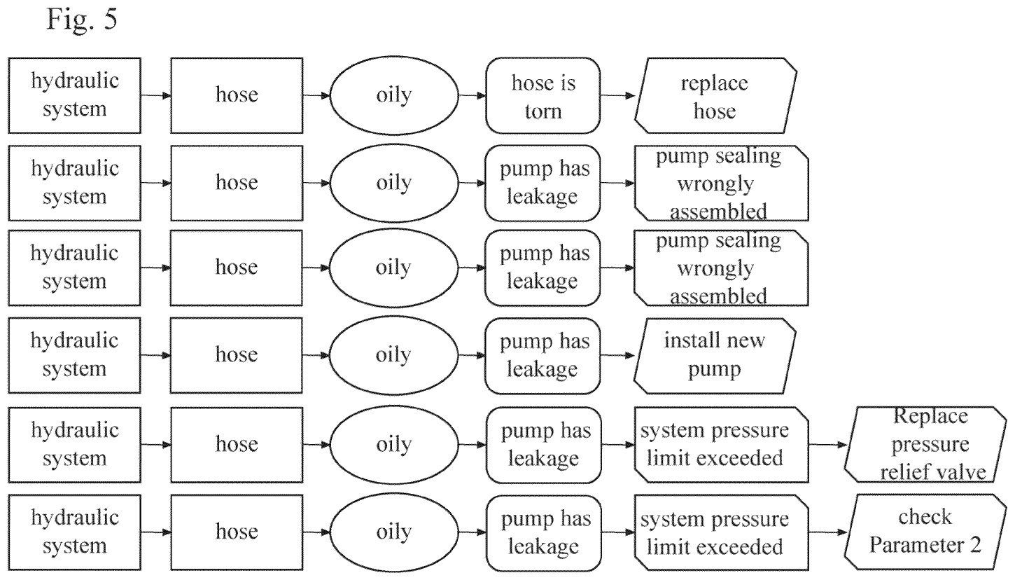

The history of confirmed paths through the knowledge database is given by the records shown in FIG. 5. These can be stored in the statistics database.

Based on this history, in the first step, the statistic probabilities Pₛₜₐₜ of the historic records are calculated according to

$${P}_{stat} = \frac{{N}_{r e l}}{{N}_{path}}$$

with Nᵣₑₗ the number of records of relations between two specific objects and Nₚₐₜₕ the number of records of the same path leading to the first object (=subject).

This gives:

$${P}_{h o s e / o i l y} = {N}_{h o s e / o i l y} / {N}_{h y d r a u l i c S y s t e m / h o s e} = 6 / 6 = 1$$

$${P}_{o i l y / h o s e l s T o r n} = {N}_{o i l y / h o s e l s T o r n} / {N}_{h y d r a u l i c S y s t e m / h o s e / o i l y} = 1 / 6 = 0 , 17$$

$${P}_{h oselsTorn / replaceHose} = {N}_{h o s e lsTorn / replaceHose} / {N}_{h y d r a u l i c S y s t e m / h o s e / o i l y / hoselsTorn} = 1 / 1 = 1$$

$${P}_{o i l y / p u m p H a s L e a k a g e} = {N}_{o i l y / p u m p H a s L e a k a g e} / {N}_{h y d r a u l i c S y s t e m / h o s e / o i l y} = 5 / 6 = 0 , 83$$

$${P}_{p u m p H a s L e a k a g e / p u m p S e a l i n g W r o n g l y A s s} . = {N}_{p u m p H a s L e a k a g e / p u m p S e a l i n g W r o n g l y A s s} . / {N}_{h y d r a u l i c S y s t e m / h o s e / o i l y / p u m p H a s L e a k a g e} = 2 / 5 = 0 , 4$$

$${P}_{p u m p H a s L e a k a g e / s y s t e m P r e s s u r e L i m i t E x c e e d e d} = {N}_{p u m p H a s L e a k a g e / s y s t e m P r e s s u reLimitExceeded} / {N}_{h y d r a u l i c S y s t e m / h o s e / o i l y / p u m p H a s L e a k a g e} = 2 / 5 = 0 , 4$$

$${P}_{p u m p H a s L e a k a g e / i n s t a l l N e w P u m p} = 1 / 5 = 0 , 2$$

$${P}_{s y s t e m P r e s s u r e L i m i t E x c e e d e d / replacePressureReliefValve} = 1 / 2 = 0 , 5$$

$${P}_{s y s t e m P r e s sureLimitExceeded / checkParameter 2} = 1 / 2 = 0 , 5 .$$

In the second step, the statistic probabilities Pₛₜₐₜ are combined with initial probabilities Pₑₓₚₑᵣₜ defined by expert knowledge leading to the weighted probabilities P_{w}.

$${P}_{w} = x \times {P}_{expert} + ( 1 - x ) \times {P}_{stat}$$

with the weighting factor x=ƒ(Nₚₐₜₕ) that depends on the number of paths Nₚₐₜₕ.

Examples for the function ƒ, can be a linear function, a Heaviside function or tan h.

Since the number of available historic records in this example is rather low, the weighting factor is selected high as x=0.9, which means that the expert knowledge has high weight.

In the last step, the weighted probabilities P_{w} are scaled such that the sum of the probabilities of each subject equals 1

$${P}_{r e l} = \frac{{P}_{w}}{Σ {P}_{w}} ,$$

which yields Table 1:

| Subject | Relation | Object | Pₑₓₚₑᵣₜ | Pₛₜₐₜ | P_{w} | Pᵣₑₗ |
|---|---|---|---|---|---|---|
| Hose | has problem | Oily | 1 | 1 | 1 | 1 |
| (component) | | | | | | |
| Oily | has cause | Hose is torn | 0.25 | 0.17 | 0.24 | 0.5 |
| Oily | has cause | Pump has leakage | 0.17 | 0.83 | 0.24 | 0.5 |
| Pump has | has cause | System pressure | 0.85 | 0.4 | 0.80 | 0.67 |
| leakage | | limit exceeded | | | | |
| Pump has | has cause | Pump sealing | 0.18 | 0.4 | 0.2 | 0.17 |
| leakage | | wrongly assembled | | | | |
| Pump has | Has solution | Install new pump | 0.2 | 0.2 | 0.2 | 0.17 |
| leakage | | | | | | |
| System | has solution | Check parameter 2 | 0.83 | 0.5 | 0.8 | 0.8 |
| pressure limit | | | | | | |
| exceeded | | | | | | |
| System | has solution | Replace pressure | 0.17 | 0.5 | 0.2 | 0.2 |
| pressure limit | | relief valve | | | | |
| exceeded | | | | | | |

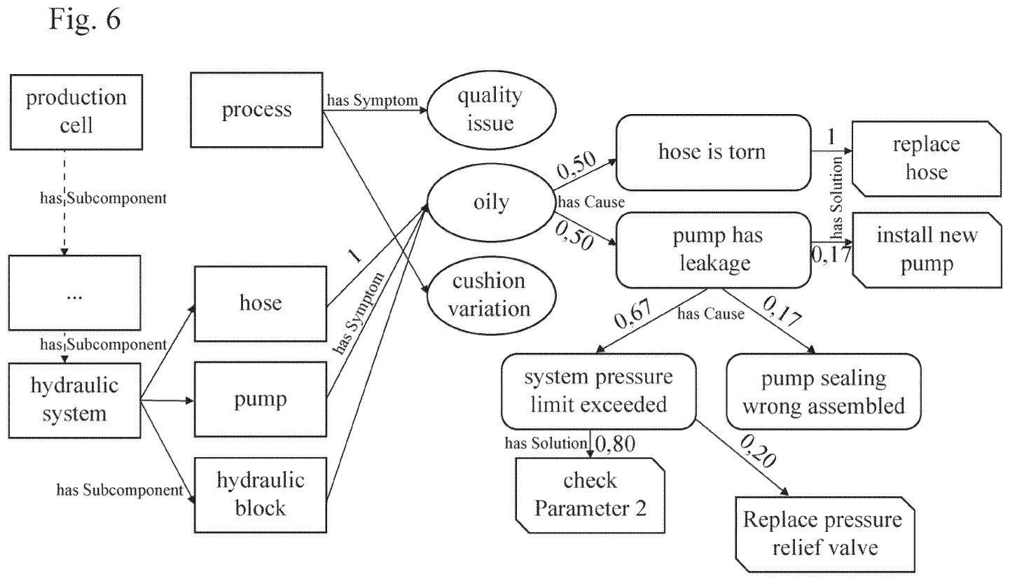

The resulting probabilities Pᵣₑₗ for each relation are shown in the graph in FIG. 6.

The probabilities can be updated with each new confirmed path or e.g., each day, after 10 new paths, . . . . Preferably, the calculated probabilities and intermediate results are stored in the statistics database to yield a small overall computational effort. However, it might also be feasible to calculate the probabilities online for each solution finding process.

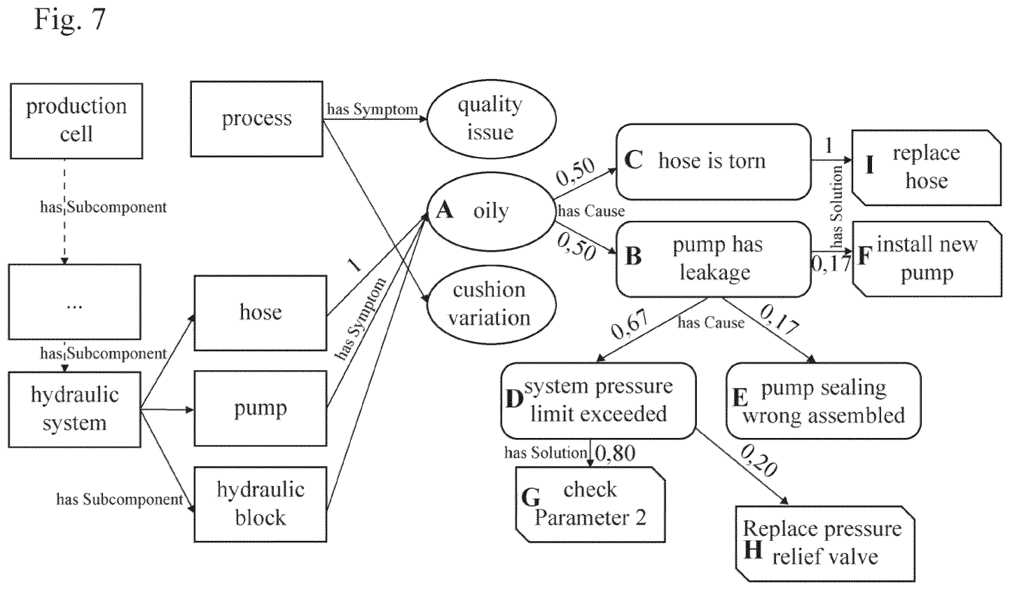

In the example of FIG. 7 the shortest-path-algorithm is used to calculate the most probable technical causes. For this example, the probabilities calculated with regard to FIGS. 5 and 6 are used. For clarity reasons in FIG. 7, the relevant objects of the knowledge graph are labeled with A-I.

In the first step, the graph with probabilities shown in FIG. 6 is converted into a matrix of distances, represented by Table 2, where the distances d are calculated as d=1−Pᵣₑₗ.

TABLE 2

| | A | B | C | D | E | F | G | H | I |
|---|---|---|---|---|---|---|---|---|---|
| A | 0 | 0.5 | 0.5 | | | | | | |
| B | | 0 | | 0.33 | 0.83 | 0.83 | | | |
| C | | | 0 | | | | | | 0 |
| D | | | | 0 | | | 0.2 | 0.8 | |
| E | | | | | 0 | | | | |
| F | | | | | | 0 | | | |
| G | | | | | | | 0 | | |
| H | | | | | | | | 0 | |
| I | | | | | | | | | 0 |

Based on the matrix of distances, the most probable technical causes can be calculated as the causes with the shortest path from “oily” (A) to each cause. For example, the shortest path can be calculated with the Dijkstra algorithm. The system can then exemplarily output the direct causes and also the indirect causes to the user.

### Direct Causes:

a. Hose is torn (total distance d=0.5)
b. Pump has leakage (d=0.5)

### Indirect Causes:

a. Pump sealing wrong assembled (d=0.67)
b. System pressure limit exceeded (d=1.17)

Note that the shortest path algorithm yields the most probable causes but does not calculate the overall probability of each cause.

In the same way, also the most probable solutions for the problem “oily” can be calculated with the shortest path algorithm:
a. Replace hose (d=0.5)
b. Check parameter 2 (d=1.03).
Install new pump (d=1.33)
d. Replace pressure relief valve (d=1.63)

If some objects in the knowledge graph are not relevant for the specific machine type (e.g., failures of a hydraulic pump at a fully electrical machine), they can be ignored in step 1 for generating the matrix of distances.

### LIST OF REFERENCES

PC Production Cell
IMM Injection Molding Machine
HMI Human Machine Interface
ECU Electronic Computing Unit
DB Database
COMP Component

1. A device for finding possible technical causes of or solutions for malfunctions of a specific production cell which is one of a plurality of possible production cells, wherein the specific production cell is built of a plurality of different objects and contains at least one cyclically operating shaping machine, the device comprising:
at least one electronic computing unit;
at least one machine interface operatively coupled to the at least one electronic computing unit; and
at least one knowledge model providing, for all production cells of the plurality of possible production cells, information that specifies for a plurality of possible malfunctions which objects that are present in one or more of the production cells of the plurality of production cells can cause a given malfunction;
wherein the at least one electronic computing unit being configured to:
accept input by an operator of the specific production cell specifying an observation observed by the operator regarding a malfunction of the specific production cell,
based on the input, access the at least one knowledge model and, for those objects which form part of the specific production cell, identify at least one object which can exhibit a malfunction which is consistent with the observation of the operator of the specific production cell,
calculate, using an algorithm, at least one technical cause of or solution for the observation provided as input by the operator, and
provide the calculated at least one technical cause or solution to the operator via the at least one machine interface.

2. The device according to claim 1, wherein the at least one electronic computing unit is configured to accept input to identify the specific production cell and/or a specific cyclically operating shaping machine.

3. The device according to claim 1, wherein the at least one electronic computing unit is configured to provide a list of possible observations to the operator via the at least one machine interface and to accept input selecting that observation of the list of possible observations which is a best match to the observation observed by the operator regarding a malfunction of the specific production cell.

4. The device of claim 1, wherein the at least one electronic computing unit is configured to provide a list of objects present in the specific production cell and to provide the list of possible observations based on a selection of a specific object made by the operator, wherein it is preferred that the list of possible observations is ordered according to the frequency of occurrence.

5. The device according to claim 1, wherein the at least one electronic computing unit is configured to operatively connect to at least one statistics database which contains the frequencies of occurrence for each observation in order to calculate at least the most probable technical cause of or solution for the observation provided as input by the operator and to provide the calculated at least one technical cause or solution to the operator via the at least one machine interface and wherein it is preferably provided that the at least one electronic computing unit is further configured to calculate a defined number of probable technical causes or solutions and to provide the calculated probable technical causes or solutions to the operator via the at least one machine interface.

6. The device according to claim 5, wherein the at least one electronic computing unit is configured to calculate the probabilities of the probable technical causes or solutions by using the frequencies of occurrence or probabilities of each technical cause or solution from the statistics database and calculating the overall probability for the combination of the selected observation and object, preferably by using a shortest path algorithm or a maximum flow algorithm.

7. The device according to claim 1, wherein the at least one electronic computing unit is configured to provide at least one proposal for a solution based on the calculated at least one technical cause to the operator via the at least one machine interface.

8. The device according to claim 7, wherein the at least one electronic computing unit is configured to calculate the combined probabilities or frequencies for different solutions based on the calculated technical causes.

9. The device according to claim 1, wherein the at least one electronic computing unit is configured to provide to the operator via the at least one machine interface at least one possible cause of or solution for the observation provided as input by the operator.

10. The device according to claim 7, wherein the at least one electronic computing unit is configured to accept input by the operator specifying whether a proposed solution has worked and to use this input to update the statistics database.

11. The device according to claim 1, wherein the at least one electronic computing unit is configured to accept input by the operator:
to build and/or update a specific knowledge model, and/or
to build and/or update the statistics database.

12. The device according to claim 1, wherein the at least one electronic computing unit is configured to:
identify at least two different objects which can exhibit a malfunction which is consistent with the observation of the operator of the specific production cell,
provide the at least two identified objects to the operator via the at least one machine interface,
accept user input by the operator selecting one of the at least two provided identified objects, and
calculate, using an algorithm, at least one technical cause of or solution for the specific combination of:
the observation provided as user input by the operator, and
the object selected by the operator.

13. A computer-implemented method for finding possible technical causes of or solutions for malfunctions of a specific production cell which is one of a plurality of production cells, wherein the specific production cell is built of a plurality of different objects and contains at least one cyclically operating shaping machine, using:
at least one electronic computing unit;
at least one machine interface operatively coupled to the at least one electronic computing unit;
at least one knowledge model providing, for all production cells of the plurality of production cells, information that specifies for a plurality of possible malfunctions which objects that are present in one or more of the productions cells of the plurality of production cells can cause a given malfunction;
and comprising at least the following steps:
accept input by an operator of the specific production cell specifying an observation observed by the operator regarding a malfunction of the specific production cell;
based on the input, access the at least one knowledge model and, for those objects which form part of the specific production cell, identify at least one object which can exhibit a malfunction which is consistent with the observation of the operator of the specific production cell;
calculate, using an algorithm, at least the most probable technical cause of or solution for the observation provided as input by the operator; and
provide the calculated at least one technical cause or solution to the operator via the at least one machine interface.

14. The method of claim 13, wherein the at least one electronic computing unit accepts input to identify the specific production cell.

15. The method of claim 13, wherein the at least one electronic computing unit provides a list of possible observations to the operator via the at least one machine interface and accepts input selecting that observation of the list of possible observations which is a best match to the observation observed by the operator regarding a malfunction of the specific production cell.

16. The method of claim 15, wherein the at least one electronic computing unit provides a list of objects present in the specific production cell and provides the list of possible observations based on a selection of a specific object made by the operator, wherein it is preferred that the list of possible observations is ordered according to the frequency of occurrence.

17. The method of claim 13, wherein the at least one electronic computing unit connects to at least one statistics database which contains the frequencies of occurrence or probabilities for each observation in order to calculate at least the most probable technical cause of or solution for the observation provided as input by the operator and provides the calculated at least one technical cause or solution to the operator via the at least one machine interface and wherein it is preferably provided that the at least one electronic computing unit further calculates a defined number of probable technical causes or solutions and provides the calculated probable technical causes or solutions to the operator via the at least one machine interface.

18. The method of claim 17, wherein the at least one electronic computing calculates the probabilities of the probable technical causes or solutions, by using the probabilities or frequencies of each technical cause or solution from the statistics database and calculating the overall probability for the combination of the selected observation and object, preferably by using a shortest path algorithm or a maximum flow algorithm.

19. The method of claim 13, wherein the at least one electronic computing unit provides at least one proposal for a solution based on the calculated at least one technical cause to the operator via the at least one machine interface.

20. The method of claim 19, wherein the at least one electronic computing unit calculates the combined probabilities or frequencies for different solutions based on the calculated technical causes.

21. The method of claim 13, wherein the at least one electronic computing unit provides to the operator via the at least one machine interface at least one possible cause for the observation provided as user input by the operator and the object selected by the operator.

22. The method of claim 13, wherein the at least one electronic computing accepts input by the operator specifying whether a proposed solution has worked and uses this input to update the statistics database.

23. The method of claim 13, wherein the at least one electronic computing unit accepts input by the operator:
to build and/or update a specific knowledge model, and/or
to build and/or update the statistics database.

24. The method of claim 13, wherein:
at least two different objects are identified which can exhibit a malfunction which is consistent with the observation of the operator of the specific production cell,
the at least two identified objects are provided to the operator via the at least one machine interface,
input by the operator selecting one of the at least two provided identified objects is accepted,
at least one technical cause or solution is calculated for the specific combination of the observation provided as input by the operator, and
the object selected by the operator.

25. A computer program which, when the program is executed by a computer, causes the computer to carry out a method according to claim 13.

26. A data carrier signal carrying the computer program of claim 25.
